(19) United States
(12) Patent Application Publication
(10) Pub. No.: US 2010/0012773 A1
(43) Pub. Date: Jan. 21, 2010

(54) Aircrft Structure

(76) Inventor: Sunstar IM, Lancaster, CA (US)

Correspondence Address: PARK LAW FIRM, 3255 WILSHIRE BLVD, SUITE 1110, LOS ANGELES, CA, 90010, US

(21) Appl. No.: 12/174,516

(22) Filed: Jul. 16, 2008

(51) Int. Cl. B64C 1/00; B64C 39/12; B64D 11/00; B64C 3/22; B64C 1/22; B64C 25/10

(52) U.S. Cl. 244/36; 244/45 A; 244/117 R; 244/118.5; 244/123.2; 244/118.1; 244/102 R; 244/119; 244/90 R

(57) ABSTRACT

An aircraft structure is provided. The aircraft structure for an aircraft includes a fuselage, front wings, rear delta wings, vertical winglets, and three levels. The fuselage has a cross-section of substantially rectangular flat shape, being is wide enough to provide lifting force, and includes three levels separated by multi-partition structure. The front wings are disposed horizontally in front portions of the fuselage. The rear delta wings are disposed horizontally in rear portions of the fuselage. The vertical winglets are disposed at wingtips of the rear delta wings. The first level disposed at a bottom of the three levels includes a cargo bay and a plurality of landing gear bays. The second level disposed at a middle of the three levels includes fuel tank storages. The third level may comprise a top cockpit and a plurality of passenger cabins. The fuselage provides major portion of lifting force and the wings provides steering force.

### BACKGROUND OF THE INVENTION

The present invention relates to an aircraft structure. More particularly, this invention relates to an aircraft structure, which includes a rectangular flat and wide body fuselage.

Aircrafts have almost same shape. The fluid dynamics in the atmosphere determines or almost dictates the shape of the aircraft. The fuselage is for carrying the load including passengers and freight. The loading capacity of the aircraft is reflected in designing of the fuselage. The wings are where the aircraft gets the lifting force. The shape and size of the wings depend on the fluid dynamics and the fuselage.

Therefore, large and strong wings have been considered natural and widely spread in almost all types of aircraft. The large wingspan and relatively stocky fuselage in cross-section has been with such kinds of fuselage.

Prior arts include U.S. Pat. Nos. 3,405,893, 3,869,102, 4,674,712, 4,836,470, 5,086,996, 5,242,132, 5,415,365, 5,813,628, 6,047,923, 6,129,308, 6,568,632, 6,666,406, 6,708,924, and 7,261,257.

To accomplish many objectives which were not possible, it is necessary to break the well-established ideas about the fuselage and the wings.

Accordingly, a need for an aircraft structure has been present for a long time. This invention is directed to solve these problems and satisfy the long-felt need.

### SUMMARY OF THE INVENTION

The present invention contrives to solve the disadvantages of the prior art.

An objective of the invention is to provide an aircraft structure.

Another object of the invention is to provide an aircraft structure, which includes a substantially rectangular flat and wide body fuselage.

Still another object of the invention is to provide an aircraft structure, which includes a fuselage having three levels.

Still another object of the invention is to provide an aircraft structure, which includes multi fuel tank storage.

Still another object of the invention is to provide an aircraft structure, which includes a wing system of reduced thickness integrated with the second level of the fuselage.

An aspect of the invention provides an aircraft structure.

The aircraft structure for an aircraft comprises a fuselage, two front wings, two rear delta wings, two vertical winglets, a first level, a second level, and a third level.

The fuselage has a cross-section of substantially rectangular flat shape in a direction of width, and the fuselage is wide enough to provide lifting force, and comprises three levels which are separated by multi-partition structure.

The two front wings are disposed horizontally in front portions of the fuselage, and are configured to control flight of the aircraft.

The two rear delta wings are disposed horizontally in rear portions of the fuselage, and are configured to provide more lifting force.

The two vertical winglets are disposed at wingtips of the corresponding rear delta wings.

The first level is disposed at a bottom of the three levels of the fuselage, and comprises a cargo bay and a plurality of landing gear bays.

The second level is disposed at a middle of the three levels of the fuselage, and comprises a plurality of fuel tank storages. Each of the plurality of fuel tank storages comprises a plurality of partition compartments. The second level is configured to anchor the front wings and the rear delta wings.

The third level is disposed at a top of the three levels of the fuselage, and comprises a top cockpit and a plurality of passenger cabins.

The fuselage provides major portion of lifting force and the wings provides steering force.

The fuselage may further comprise a bottom cockpit at a front portion of a belly of the fuselage. The bottom cockpit may be for controlling the aircraft during take-off and landing, and may comprise one or more window facing downward.

The fuselage may float in water.

The third level may further comprise a plurality of seating systems and bedding systems. The third level may further comprise a plurality of doors along both sides of the fuselage.

The aircraft structure may further comprise a spoiler at a rear top portion of the fuselage.

Each of the two front wings may comprise an elevator. Each of the two front wings may have a cross-sectional shape of lamina flow.

Each of the two front wings and the two rear delta wings may comprise a plurality of aluminum rectangular tubes with a plurality of punched holes, the tubes being interconnected at a plurality of assembling cutaways provided in the tubes and welded in a grid structure.

The cargo bay in the first level may comprise a plurality of doors for loading and unloading.

Some of the plurality of landing gear bays may be aligned in two parallel lines in the first level, and opened downwardly from under a belly portion of the fuselage.

The first level may further comprise a plurality of hydraulic operating system and pneumatic system for controlling the landing gears.

Each of the fuselage, walls, floors, and roofs for the three levels may comprise a plurality of aluminum rectangular tubes interconnected at a plurality of assembling cutaways provided in the tubes and welded in a net grid structure. The tubes may further include still other holes for electric, pneumatic, and hydraulic lines or pipes. The tubes of these types are necessary in almost all the parts of the aircraft including wings.

The net grid structure may comprise a plurality of fire retardant foam panels between the tubes. Alternatively, the net grid structure may comprise a plurality of fire retardant foam panels around the tubes.

Still in other embodiments, the net grid structure may comprise a plurality of fire retardant foam panels between the tubes, and each of the plurality of fire retardant foam panels may have a honey comb structure.

The second level may further comprise one or more pumping station and valve controlling gauges.

The second level may be integrated with the two front wings and the two rear delta wings.

Each of some of the two front wings and the two rear delta wings may comprise one or more elevons.

Each of the two vertical winglets may comprise a stabilizer.

Another aspect of the invention provides an aircraft structure for an aircraft, comprising a fuselage having a cross-section of substantially rectangular flat shape in a direction of width, the fuselage being wide enough to provide lifting force, wherein the fuselage comprises three levels, an upper surface, and a lower surface, wherein the three levels are separated by multi-partition structure, and wherein the upper surface of the fuselage has an airfoil form to provide lifting force.

The advantages of the present invention are: (1) the aircraft structure can provide more lift with the flat fuselage; and (2) the aircraft structure enables three levels of structure for accommodating more space separated independently.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing an aircraft having a structure according to an embodiment of the present invention;

FIG. 2 is a top plan view of the aircraft of FIG. 1;

FIG. 3 is a side plan view of the aircraft of FIG. 1;

FIG. 4 is a cross-sectional side view of the aircraft of FIG. 1 showing three levels;

FIG. 5 is a front plan view of the aircraft of FIG. 1;

FIG. 6 is a rear plan view of the aircraft of FIG. 1;

FIG. 7 is a perspective top view of an aircraft according to another embodiment of the invention;

FIG. 8 is a perspective bottom view of the aircraft of FIG. 7;

FIG. 9 is an exploded perspective partial cut-out view of the aircraft of FIG. 7;

FIG. 10 is a cross-sectional side view of an aircraft according to still another embodiment of the invention;

FIG. 11 is a cross-sectional top view of an aircraft according to still another embodiment of the invention;

FIG. 12 is a perspective top and partial cross-sectional view of an aircraft according to an embodiment of the invention;

FIG. 13 is a cross-sectional front view of the aircraft of FIG. 12;

FIG. 14 is a perspective partial cut-out view of a cabin in an aircraft according to an embodiment of the invention; and

FIG. 15 is a perspective partial cross-sectional view of a fuselage according to an embodiment of the invention.

### DETAILED DESCRIPTION EMBODIMENTS OF THE INVENTION

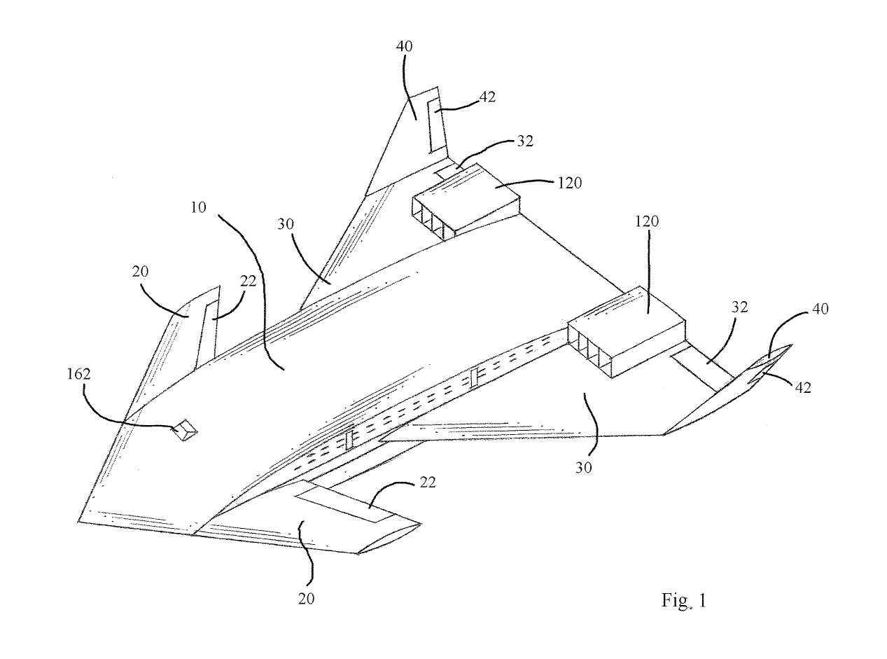

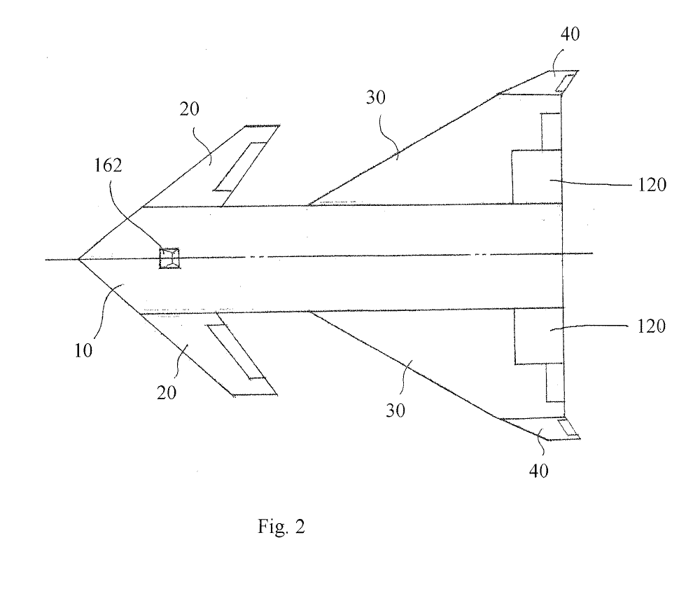

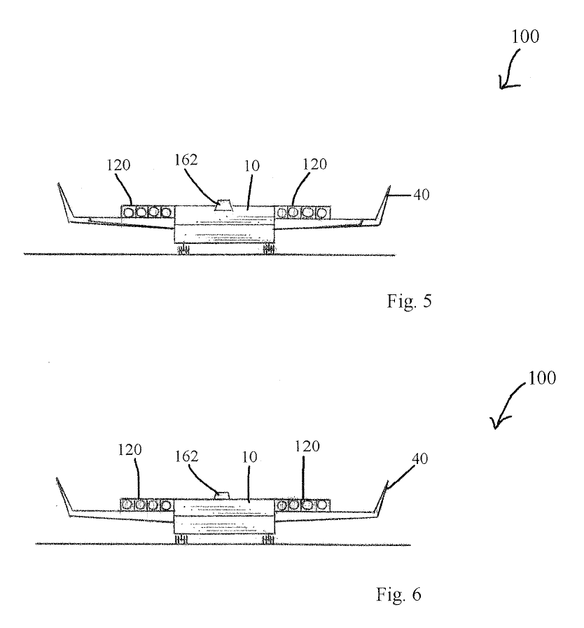

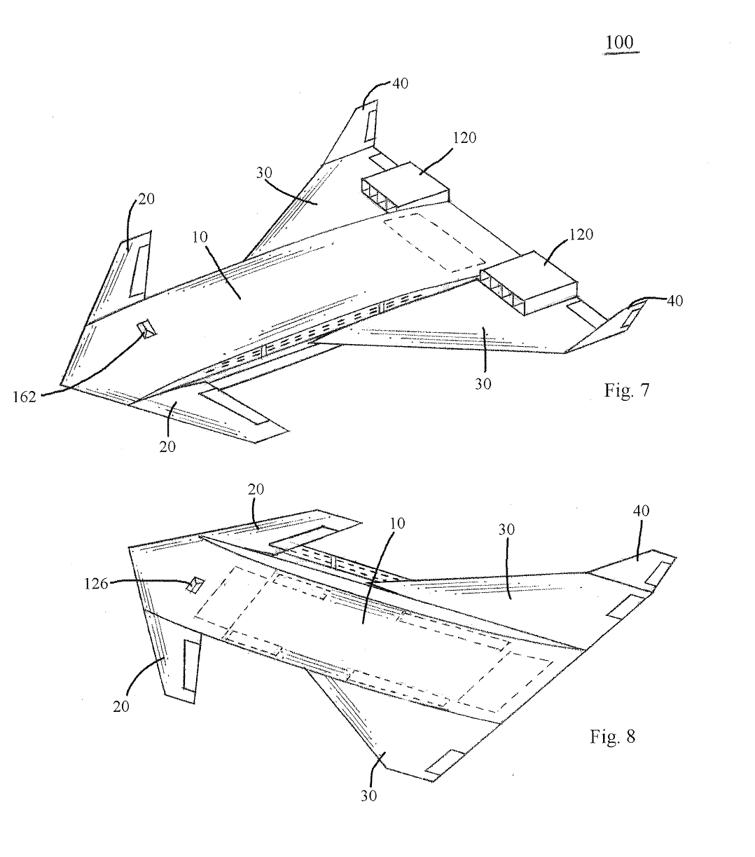

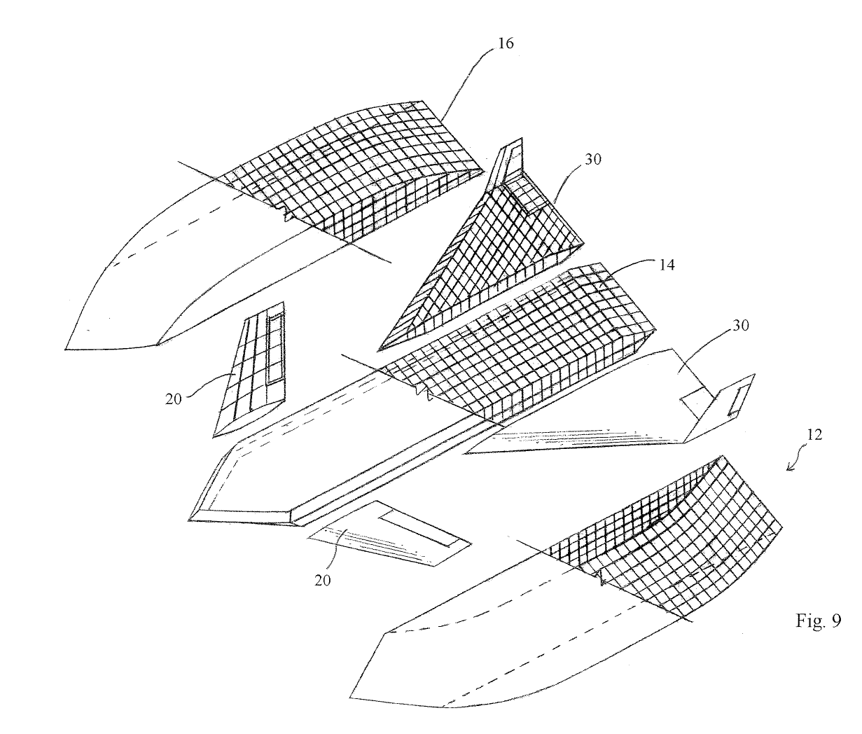

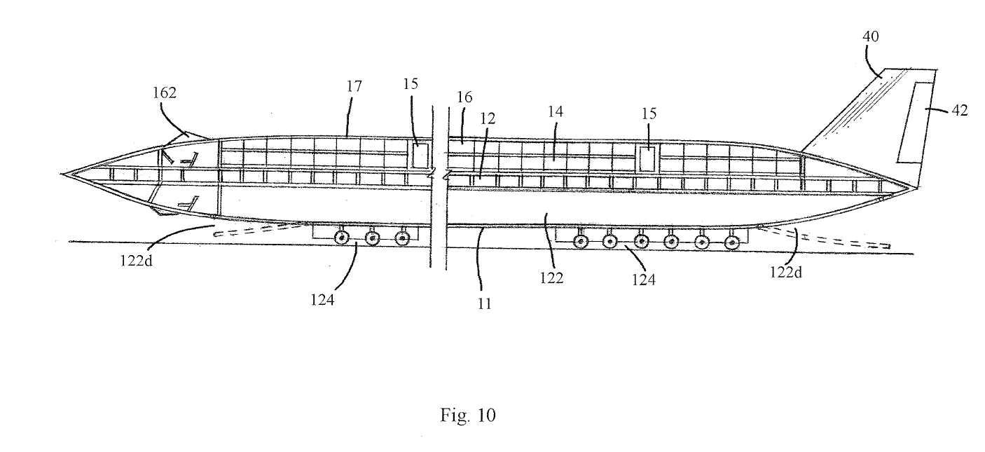

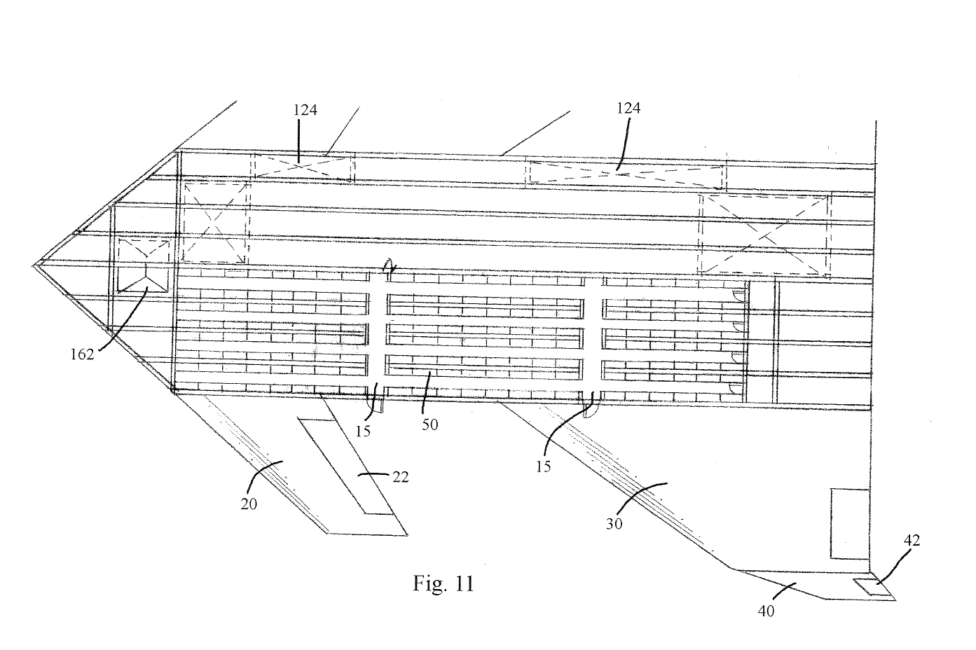

FIGS. 1-8 show an aircraft 100 according to embodiments of the present invention. FIGS. 9-15 show inner structures of the aircraft 100.

An aspect of the invention provides the illustrated structure of the aircraft 100.

The aircraft structure for an aircraft 100 comprises a fuselage 10. The aircraft structure for an aircraft 100 may further comprise two front wings 20, two rear delta wings 30, and two vertical winglets 40. The aircraft structure for an aircraft 100 may comprise a first level 12, a second level 14, and a third level 16.

The fuselage 10 has a cross-section of substantially rectangular flat shape in a direction of width, and the fuselage 10 is wide enough to provide lifting force, and comprises three levels which are separated by multi-partition structure as shown in FIGS. 4, 9, and 10.

The two front wings 20 are disposed horizontally in front portions of the fuselage 10, and are configured to control flight of the aircraft 100.

The two rear delta wings 30 are disposed horizontally in rear portions of the fuselage 10, and are configured to provide more controlling and lifting force.

The two vertical winglets 40 are disposed at wingtips of the corresponding rear delta wings 30.

The first level 12 is disposed at a bottom of the three levels of the fuselage 10, and comprises a cargo bay 122 and a plurality of landing gear bays 124.

The second level 14 is disposed at a middle of the three levels of the fuselage 10, and comprises a plurality of fuel tank storages 142. Each of the plurality of fuel tank storages comprises a plurality of partition compartments 144. The second level 14 is configured to anchor the front wings 20 and the rear delta wings 30.

The third level 16 is disposed at a top of the three levels of the fuselage 10, and comprises a top cockpit 162 and a plurality of passenger cabins 164.

The fuselage 10 provides major portion of lifting force and the wings 20, 30 provide steering force mainly. The wings 20, 30 also provide some lifting force.

The fuselage 10 may further comprise a bottom cockpit 126 at a front portion of a belly of the fuselage 10 as shown in FIG. 8. The bottom cockpit 126 may be for controlling the aircraft 100 during take-off and landing, and may comprise one or more window facing downward.

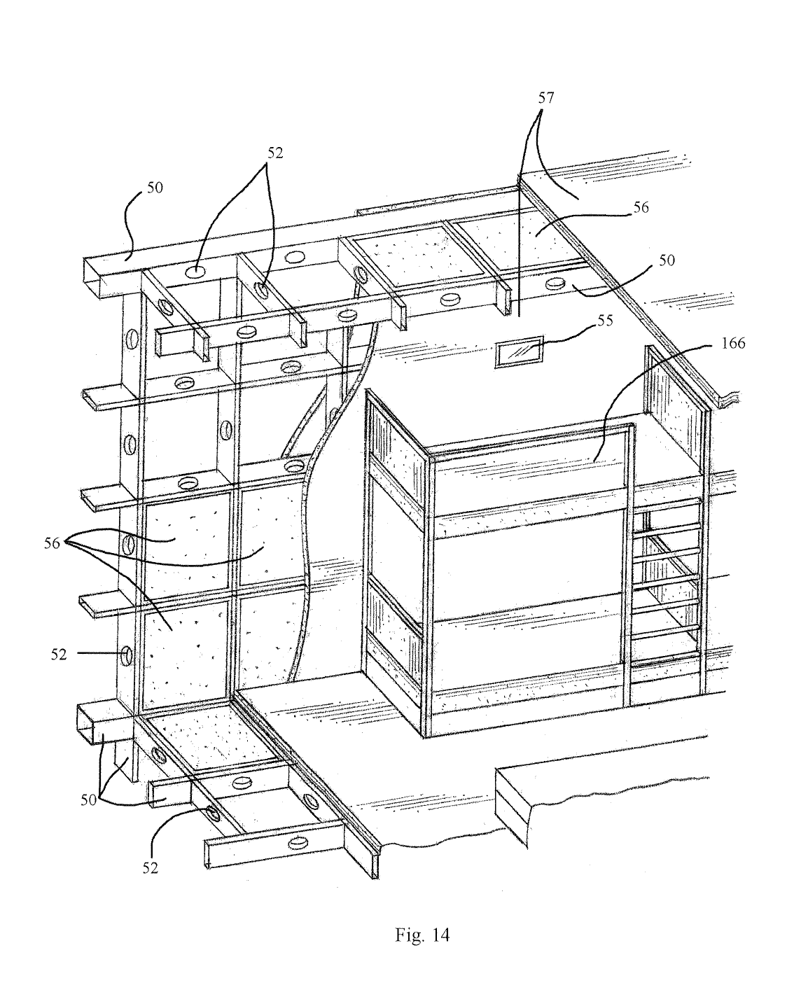

The fuselage 10 may float in water due to the aluminum structure tube with fire retardant foam sealed with honeycomb aluminum panel 57 with glue as shown in FIG. 14. Since such a structure is water tight as well as air tight, the aircraft may be a sea plane used on a sea port.

The third level 16 may further comprise a plurality of seating systems and bedding systems 166. The third level 16 may further comprise a plurality of doors along both sides of the fuselage 10.

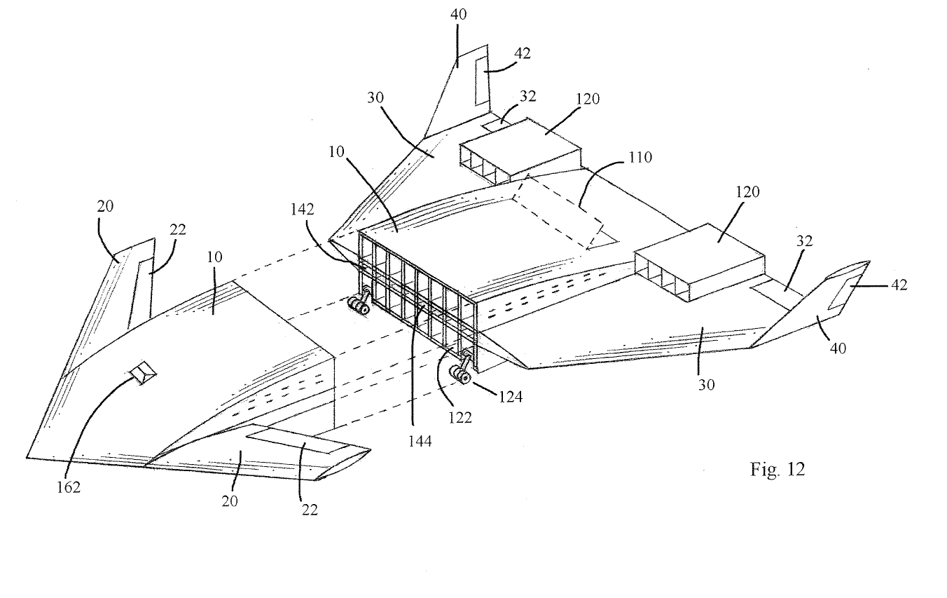

The aircraft structure may further comprise a spoiler 110 at a rear top portion of the fuselage 10 as shown in FIG. 12.

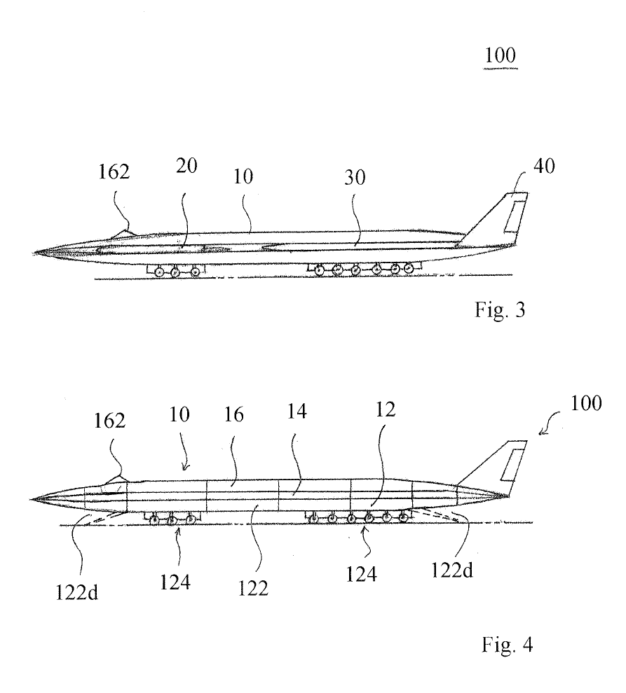

Each of the two front wings 20 may comprise an elevator 22. Each of the two front wings 20 may have a cross-sectional shape of lamina flow as clearly seen in FIGS. 3, 4, and 10. The air foil shape is provided with the wings 20, 30. However, since their size is small, the lifting force by the wings is minor compared to the lifting force of the fuselage 10. The ratio of the two lifting forces may be predetermined to optimize the flight.

Each of the two front wings 20 and the two rear delta wings 30 may comprise a plurality of aluminum rectangular tubes 50 with a plurality of punched holes 52, the tubes 50 being interconnected at a plurality of assembling cutaways 54 provided in the tubes 50 and welded in a grid structure as shown in FIGS. 9, 16, 17, and 18.

The cargo bay 122 in the first level 12 may comprise a plurality of doors 122d for loading and unloading.

Some of the plurality of landing gear bays 124 may be aligned in two parallel lines in the first level 12, and opened downwardly from under a belly portion of the fuselage 10 as shown in FIGS. 3, 4, 8, 10, and 15.

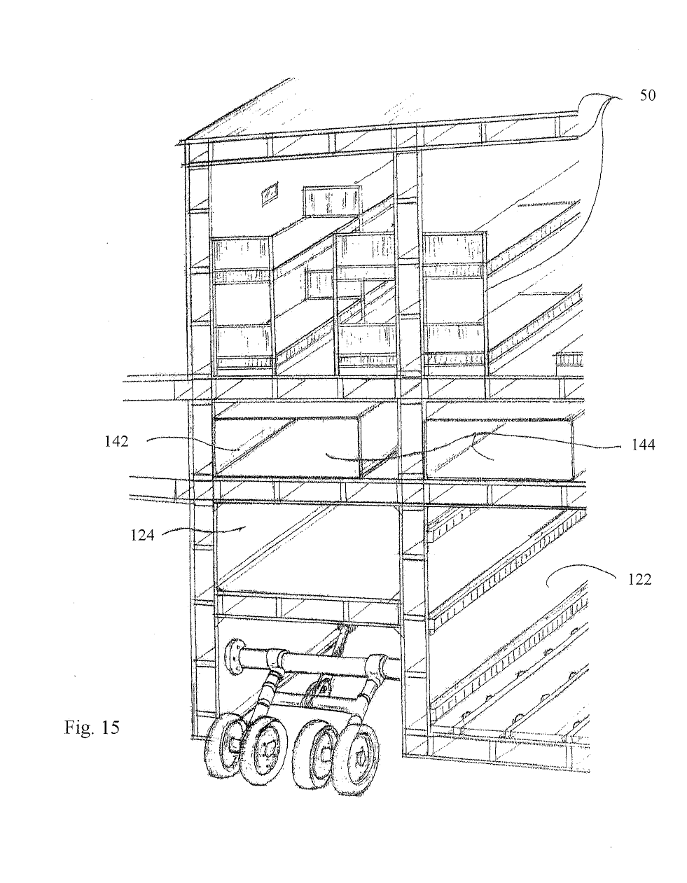

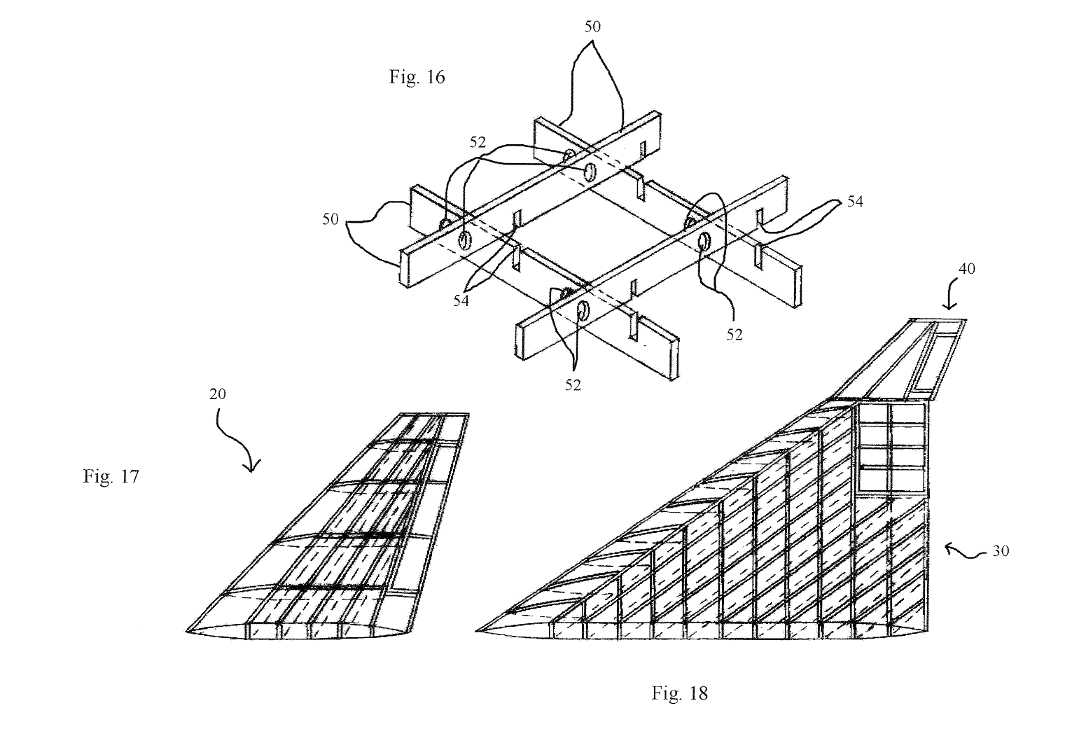

The first level 12 may further comprise a plurality of hydraulic operating system and pneumatic system for controlling the landing gears as shown in FIG. 15.

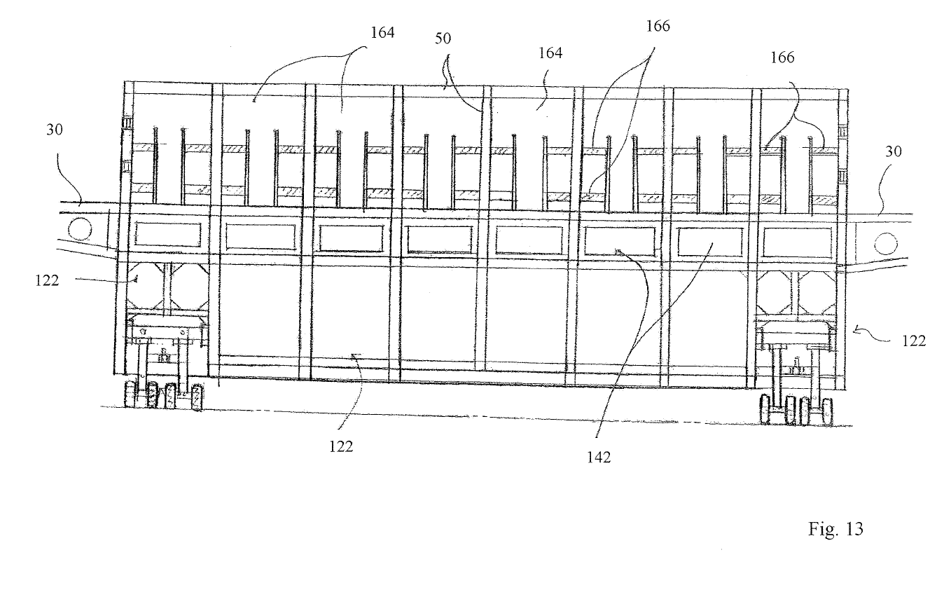

Each of the fuselage 10, walls, floors, and roofs for the three levels 12, 14, 16 may comprise a plurality of aluminum rectangular tubes 50 interconnected at a plurality of assembling cutaways 54 provided in the tubes 50 and welded in a net grid structure 55 as shown in FIGS. 13-15.

The net grid structure may comprise a plurality of fire retardant foam panels 56 between the tubes 50 as shown in FIG. 14. Alternatively, the net grid structure may comprise a plurality of fire retardant foam panels 56 around the tubes 50.

Still in other embodiments, the net grid structure may comprise a plurality of fire retardant foam panels 56 between the tubes 50, and each of the plurality of fire retardant foam panels 56 may have a honey comb structure 57.

The second level 14 may further comprise one or more pumping station and valve controlling gauges for fuel storage.

The second level 14 may be integrated with the two front wings 20 and the two rear delta wings 30 as shown in FIG. 13.

Each of some of the two front wings 20 and the two rear delta wings 30 may comprise one or more elevons 22, 32.

Each of the two vertical winglets 40 may comprise a stabilizer 42.

Another aspect of the invention provides an aircraft structure for an aircraft 100, comprising a fuselage 10 having a cross-section of substantially rectangular flat shape in a direction of width, the fuselage 10 being wide enough to provide lifting force, wherein the fuselage 10 comprises three levels 12, 14, 16, an upper surface 11, and a lower surface 17, wherein the three levels 12, 14, 16 are separated by multi-partition structure, and wherein the upper surface 11 and the lower surface 17 of the fuselage 10 has an airfoil form to provide lifting force.

One or more power plants 120 of the aircraft for providing power are provided on a portion of the rear delta wings 30 as shown in FIGS. 1, 2, 5-7, and 12.

The arrangement of the structure employs an aircraft building block system, in which it is possible to modify and exchange the first, second, and third levels if desired.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An aircraft structure for an aircraft, comprising:
a fuselage having a cross-section of substantially rectangular flat shape in a direction of width, the fuselage being wide enough to provide lifting force, wherein the fuselage comprises three levels, and wherein the three levels are separated by multi-partition structure,
wherein the fuselage provides major portion of lifting force and the wings provides steering force.

2. The aircraft structure of claim 1, further comprising:
two front wings disposed horizontally in front portions of the fuselage, the two front wings being configured to control flight of the aircraft;
two rear delta wings disposed horizontally in rear portions of the fuselage, the two rear delta wings being configured to provide more lifting force; and
two vertical winglets, each of which being disposed at a wingtip of a corresponding one of the two rear delta wings.

3. The aircraft structure of claim 2, further comprising:
a first level disposed at a bottom of the three levels of the fuselage, wherein the first level comprises a cargo bay and a plurality of landing gear bays;
a second level disposed at a middle of the three levels of the fuselage, wherein the second level comprises a plurality of fuel tank storages, wherein each of the plurality of fuel tank storages comprises a plurality of partition compartments, and wherein the second level is configured to anchor the front wings and the rear delta wings; and
a third level disposed at a top of the three levels of the fuselage, wherein the third level comprises a top cockpit and a plurality of passenger cabins.

4. The aircraft structure of claim 3, wherein the fuselage further comprises a bottom cockpit at a front portion of a belly of the fuselage, wherein the bottom cockpit is for controlling the aircraft during take-off and landing, and comprises one or more window facing downward.

5. The aircraft structure of claim 3, wherein the fuselage floats in water.

6. The aircraft structure of claim 3, wherein the third level further comprises a plurality of seating systems and bedding systems, and wherein the third level further comprises a plurality of doors along both sides of the fuselage.

7. The aircraft structure of claim 3, further comprising a spoiler at a rear top portion of the fuselage, wherein each of the two front wings comprises an elevator.

8. The aircraft structure of claim 7, wherein each of the two front wings has a cross-sectional shape of lamina flow.

9. The aircraft structure of claim 3, wherein each of the two front wings and the two rear delta wings comprises a plurality of aluminum rectangular tubes with a plurality of punched holes, the tubes being interconnected at a plurality of assembling cutaways provided in the tubes and welded in a grid structure.

10. The aircraft structure of claim 3, wherein the cargo bay in the first level comprises a plurality of doors for loading and unloading, and wherein the plurality of doors are provided on front and rear portion of the bottom of the fuselage.

11. The aircraft structure of claim 3, wherein some of the plurality of landing gear bays are aligned in two parallel lines in the first level, and opened downwardly from under a belly portion of the fuselage, and wherein the first level further comprises a plurality of hydraulic operating system and pneumatic system for controlling the landing gears.

12. The aircraft structure of claim 3, wherein each of the fuselage, walls, floors, and roofs for the three levels comprises a plurality of aluminum rectangular tubes interconnected at a plurality of assembling cutaways and punched holes provided in the tubes and welded in a net grid structure, and wherein the net grid structure comprises a plurality of fire retardant foam panels between the tubes.

13. The aircraft structure of claim 12, wherein the net grid structure comprises a plurality of fire retardant foam panels around the tubes.

14. The aircraft structure of claim 12, wherein the net grid structure comprises a plurality of fire retardant foam panels between the tubes, wherein each of the plurality of fire retardant foam panels has a honey comb structure.

15. The aircraft structure of claim 3, wherein the second level further comprises one or more pumping station and valve controlling gauges.

16. The aircraft structure of claim 3, wherein the second level is integrated with the two front wings and the two rear delta wings.

17. The aircraft structure of claim 3, wherein each of some of the two front wings and the two rear delta wings comprises one or more elevens, and wherein each of the two vertical winglets comprises a stabilizer.

18. The aircraft structure of claim 3, wherein the three levels comprises a building block system such that the disposition of the first, second, and third levels is interchangeable.

19. An aircraft structure for an aircraft, comprising:
a fuselage having a cross-section of substantially rectangular flat shape in a direction of width, the fuselage being wide enough to provide lifting force, wherein the fuselage comprises three levels, an upper surface, and a lower surface, and wherein the three levels are separated by multi-partition structure,
wherein the upper surface of the fuselage has an airfoil form to provide lifting force.
